(19) United States
(12) Patent Application Publication
(10) Pub. No.: US 2015/0128017 A1
(43) Pub. Date: May 7, 2015

(54) ENABLING INTERACTIVE SCREENSHOTS WITHIN COLLABORATIVE APPLICATIONS

(71) Applicant: International Business Machines Corporation, Armonk, NY (US)

(72) Inventors: RACHEL H. FITHIAN, RALEIGH, NC (US); JEREMY R. GEDDES, RALEIGH, NC (US); HUGH E. HOCKETT, RALEIGH, NC (US); AARON J. QUIRK, CARY, NC (US)

(73) Assignee: International Business Machines Corporation, Armonk, NY (US)

(21) Appl. No.: 14/073,124

(22) Filed: Nov. 6, 2013

(51) Int. Cl. G06F 17/22

(52) U.S. Cl. CPC G06F 17/2235
USPC 715/205

(57) ABSTRACT

A resource link within a selected portion of an interface can be identified. The link can include a visible interface element and a non-visible reference to a resource. The reference can be a Uniform Resource Identifier. The identity of an application associated with the interface can be established. The identity can be an application or process identifier. The position/dimensions of the element within the selected portion can be determined. A screenshot image of the current state of the selected portion can be captured. The state can include a visual representation of the element. The position/dimensions of the element can be encoded within an image map. The encoding can map a bounded region surrounding the representation of the element within the screenshot corresponding to the element position/dimension of the link within the interface. The region can be associated with the identity of the application and the reference.

### BACKGROUND

The present invention relates to the field of and, more particularly, to enabling interactive screenshots within collaborative applications.

Applications such as instant messaging applications and productivity applications allow users to easily collaborate to perform important tasks. Many times, these applications include collaborative features such as shared tasks lists and group notes. These features can offer a high degree of collaboration when users interact with these applications. A common feature of these applications often includes screen capture functionality. The functionality allows a user to create a snapshot of the screen (e.g., screenshot) of an application at a particular time. These screenshots are an easy way to share complex information between users. Often times, screenshots are used in situations where computing resources are limited since the screenshot image data size can be trivial.

As such, users frequently share the snapshot with other users via email, chat, and e-meeting (e.g., Web conference) tools. The screenshot is typically a static image bitmap with which users cannot interact. For example, when a screenshot of a tutorial video is received by a recipient, the recipient cannot easily access the video without performing a series of complicated steps to identify the video Uniform Resource Locator. (e.g., searching for a video name in a search engine). As such, screenshots can have limited extended value after viewing.

### BRIEF SUMMARY

One aspect of the present invention can include a system, an apparatus, a computer program product, and a method for enabling interactive screenshots within collaborative applications. A resource link within a selected portion of an interface can be identified. The link can include a visible interface element and a non-visible reference to a resource. The reference can be a Uniform Resource Identifier. The identity of an application associated with the interface can be established. The identity can be an application or process identifier. The position/dimensions of the element within the selected portion can be determined. A screenshot image of the current state of the selected portion can be captured. The state can include a visual representation of the element. The position/dimensions of the element can be encoded within an image map. The encoding can map a bounded region surrounding the representation of the element within the screenshot corresponding to the element position/dimension of the link within the interface. The region can be associated with the identity of the application and the reference.

Another aspect of the present invention can include an apparatus, a computer program product, a method, and a system for enabling interactive screenshots within collaborative applications. A content sharing engine can be configured to create an interactive screenshot of an interactive region. The sharing engine can be able to access a resource associated with the region responsive to selecting the interactive region. The screenshot can be a recorded image of a selected portion of an application interface executing within a computing device; a data store can be able to persist a screenshot image, a link metadata, and a mapping.

### BRIEF DESCRIPTION OF THE SEVERAL VIEWS OF THE DRAWINGS

FIG. 1 is a schematic diagram illustrating a scenario and a system for enabling interactive screenshots within collaborative applications in accordance with an embodiment of the inventive arrangements disclosed herein.

FIG. 2A is a schematic diagram illustrating a method for creating an interactive screenshot in accordance with an embodiment of the inventive arrangements disclosed herein.

FIG. 2B is a schematic diagram illustrating a method for presenting and interacting with an interactive screenshot in accordance with an embodiment of the inventive arrangements disclosed herein.

FIG. 3 is a schematic diagram illustrating a system for enabling an interactive screenshot between collaborative applications in accordance with an embodiment of the inventive arrangements disclosed herein.

FIG. 4 is a schematic diagram illustrating a set of interfaces for enabling an interactive screenshot between collaborative applications in accordance with an embodiment of the inventive arrangements disclosed herein.

### DETAILED DESCRIPTION

The present disclosure is a solution for enabling interactive screenshots within collaborative applications. In the solution, a region of an interface can be selected. A screenshot image of the selected region can be captured. The region can be analyzed to determine an active application presenting a hyperlink within the region. The application can expose the hyperlink data and hyperlink metadata. The data and metadata can be mapped to a corresponding region within the screenshot image. The corresponding region can be interactive permitting access to a resource associated with hyperlink. Selection of the corresponding region can trigger programmatic actions to be performed such as presenting the resource associated with the hyperlink.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

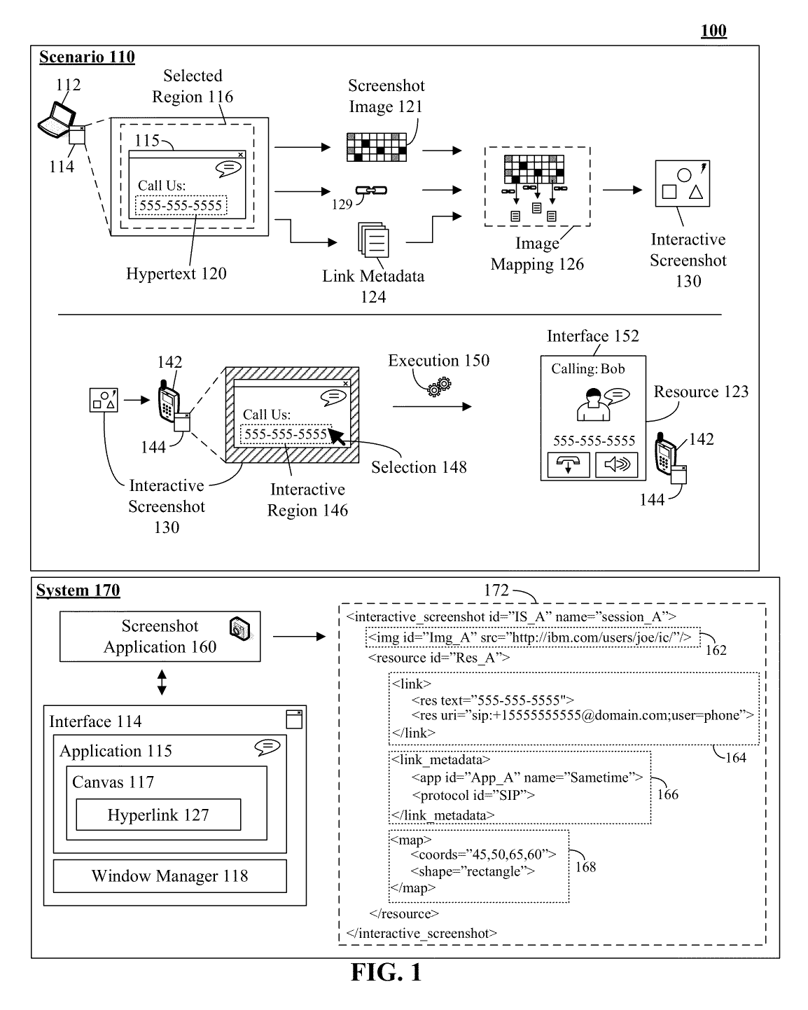

FIG. 1 is a schematic diagram illustrating a scenario 110 and a system 170 for enabling interactive screenshots within collaborative applications in accordance with an embodiment of the inventive arrangements disclosed herein. In scenario 110, an interactive screenshot 130 can permit selection 148 of an interactive region 146 of an image 121 to present resource 123. In system 170, screenshot application 160 can communicate with an interface 114 via window manager 118 to support capabilities of an interactive screenshot 130.

In scenario 110, two computing devices 112, 142 can be communicatively linked via one or more networks. In one instance, devices 112, 142 can execute an application 115, 144 which can communicate in real-time or near real-time. For example, application 115, 144 can be an IBM SAMETIME messaging application.

In scenario 110, a hyperlink 127 can be present within an application 115 executing within an interface 114 of computing device 112. The hyperlink 127 can be visibly presented within application 115 as hypertext 120. Hyperlink 127 can include a reference 129 (e.g., Uniform Resource Locator) to a resource 123. For example, hypertext 120 present an interactive link which when clicked (e.g., mouse click) causes a Web browser to navigate to a resource such as a Web site (e.g., http://www.ibm.com).

A screenshot image 121 of the interface 114 can be captured by screenshot application 160 and/or an operating system utility (e.g., via pressing the “Print Screen” button). That is, screenshot application 160 can create an image of visible items within a selected region 116. For example, image 121 can include a window of an application 115 presenting a hypertext 120. In one instance, the image 121 can be created based on selected region 116. For example, image 121 can be automatically generated once a selected region 116 is drawn on interface via a selection tool (e.g., marquee).

It should be appreciated that selected region 116 can be manually and/or automatically determined by application 160. For example, a lasso selection tool can permit the creation of a non-uniform (e.g., irregular) selected region 116 around a Web browser application displaying the content of a Web page. In one instance, region 116 can be automatically determined and image 121 can be created without region 116 visibility being presented.

In one embodiment, selected region 116 can be automatically determined using traditional selection preferences. In the embodiment, region 116 can be automatically determined using interface focus information, user preferences and the like. For example, selected region 116 can include the whole screen (e.g., entirety of interface 114) or an application window with focus.

It should be appreciated that image 121 can be created from interaction with window manager 118, a graphics application programming interface (API), graphics library, and the like. For example, image 121 can be generated from querying a screen capture function of an interface such as a desktop window manager. It should be appreciated that image 121 can conform to common formats such as a (Joint Photographic Expert Group) JPEG or BITMAP format.

Image 121 can be recorded and can be temporarily or permanently stored within a data store. For example, application 160 can persist the image 121 within an operating system clipboard. Upon creation of image 121, the disclosure (e.g., system 170, engine 320) can extract a reference 129 associated with hypertext 120 from selected region 116. In one instance, an application 115 presenting hypertext 120 within region 116 can be identified and can be queried to expose reference 127 to application 160. For example, application 160 can utilize common data interchange formats/processes and interprocess communication protocols to obtain hyperlink 127 data.

In one instance, application 160 can extract hypertext 120, reference 129 data, and/or link metadata 124 from hyperlink 127. For example, application 160 can extract a Session Initiated Protocol (SIP) phone number of a user (e.g., 555-555-5555) when hyperlink 127 is a SIP URL. It should be appreciated that hyperlink 127 can include a Uniform Resource Locator.

In one embodiment, link metadata 124 can be extracted during image 121 creation to aid in processing region 146 interaction. In the embodiment, metadata 124 can specify a data representation preference, a data handling preference, and the like. For example, metadata 124 can specify an appropriate application to utilize during execution 150.

The extracted data 124, 129 can be appropriately associated with image 121 via image mapping 126 process. Mapping 126 can include data 124, 129 transformation, data 124, 129 encoding, and the like.

In one instance, reference 129 can be mapped to an interactive region 146 of screenshot 130 based on the position and/or dimensions of hypertext 120 within interface 114. In the instance, reference 129 can be logically mapped to region 146 which can directly correspond to the position and/or dimensions of hypertext 120. For example, a rectangular area map within screenshot 130 can be generated from position and/or dimension information of hypertext 120. That is, an image map (e.g., map 168) can specify coordinates/dimensions for reference 129 within screenshot 130 enabling the region to be interactive.

In one embodiment, reference 129 and metadata 124 can be embedded into image 121 to create an interactive screenshot 130. In the embodiment, metadata 172 can encode reference 129 and metadata 124 within image 121. For example, metadata 172 can be an Extensible Markup Language document which can enable one or more hyperlinks 127 within application 115 to be mapped to an image 121 to enable subsequent interaction with the image.

Upon completion of image mapping 126 process, an interactive screenshot 130 can be generated and/or conveyed. Screenshot 130 can be conveyed to a device 142 and can be presented within an interface of an application 144. In one instance, the interface 144 can be an operating system interface, an application interface, and the like.

Screenshot 130 can be presented within an interface 144 computing device 142 responsive to the device 142 receiving the screenshot 130. For example, screenshot 130 can be an image within an electronic mail (e-mail) which can automatically presented when the e-mail is opened. Screenshot 130 can include an interactive region 146 which can represent hypertext 120 in appearance and/or function.

It should be appreciated that the disclosure can permit traditional image manipulation of screenshot 130. Image manipulation can include, but is not limited to, resizing, rotation, mirroring, printing, and the like. For example, screenshot 130 can be resized (e.g., stretched/shrunk) horizontally or vertically without affecting the mapping of interactive regions.

In one instance, region 146 can be triggered in the same manner as selection of hypertext 120. In the instance, region 146 can appear to have the same interactivity as a hypertext 120 (e.g., selection, copy link location, etc). For example, the hyperlink 127 associated with region 146 can be bookmarked in the same manner as a hyperlink 127 reference of hypertext 120.

Region 146 can be a user interactive region which can trigger execution 150 upon selection 148. For example, when region 146 is selected with a mouse cursor, a resource 123 associated with the reference 129 can be presented. In one instance, execution 150 can trigger the presentation of an interface 152 which can permit access to resource 123. In the instance, execution 150 can automatically process reference 129 and/or metadata 124 to access an appropriate resource 123 associated with the hypertext 120. For example, execution 150 can launch a phone application which can automatically initiate a call to a user (e.g., Bob) associated with the phone number (e.g., 555-555-5555). It should be appreciated that execution 150 can include client side execution or server side execution.

In one embodiment, metadata 124 can permit a session associated with an application to be accessed. For example, metadata 124 can include session information which can enable a user to join a videoconference session by clicking on region 146.

In system 170, a screenshot application 160 can interface with a window manager 118 to create a mapping (e.g., code 168 of metadata 172) which can enable screenshot 130 capabilities. System 170 can facilitate scenario 110 processes including, but not limited to, reference 128 extraction, link metadata 124 extraction, image mapping 126, screenshot 130 conveyance, execution 150, and the like. In one instance, system 170 can generate a screenshot metadata 172 which can enable interactive region 146 capabilities by embedding metadata 172 within image 121.

It should be appreciated that the disclosure is not limited to embedding metadata 172 within image. In one embodiment, a reference to metadata 172 can be associated with image 121, enabling metadata 172 to be accessed when image 121 is viewed.

Metadata 172 can be automatically created by application 160 upon selection of a screen capture action. It should be appreciated that metadata 172 can conform to one or more data exchange formats including, but not limited to Extensible Markup Language, JAVASCRIPT Object Notation (JSON), Resource Description Framework (RDF), and the like.

In one instance, metadata 172 can include an interactive screenshot identifier, an image identifier 162, a reference data 164, a link metadata descriptor 166, an image map 168, and the like.

Image 121 can be associated with metadata 172 via image identifier 162 properties. For example, identifier 162 can permit metadata 172 to be stored and/or communicated independent from image 121.

In one instance, reference data 172 can be utilized to encode data 124, 129 extracted from hyperlink 127.

In one embodiment, descriptor 166 can enable specialized handling of the reference 129 associated with region 146. In the embodiment, descriptor 166 parameters can facilitate cross-platform usability by specifying source and/or target protocol/data settings. For example, descriptor 166 can be utilized to specify a protocol type (e.g., Wireless Application Protocol) to utilize when processing reference 129 on a mobile phone in response to region 146 interaction.

In one instance, map 168 can be created utilizing coordinates and/or dimension information obtained from the application 115 based on the position of hypertext 120 within canvas 117. It should be appreciated that coordinates/dimensions can be translated from an offset when selected region 116 dimensions are different (e.g., smaller, larger) than interface 114.

It should be appreciated that interactive region 146 can be associated with a hyperlink 127, a different hyperlink with a reference to resource 123, a callback functionality, and the like. In one instance, region 146 can be associated with an asynchronous callback function which can execute to present resource 123 upon selection of region 146 and perform one or more actions. For example, region 146 can trigger accessing a user calendar and presenting an add event calendar interface to add an event associated with reference 129 (e.g., hypertext 120).

Drawings presented herein are for illustrative purposes only and should not be construed to limit the invention in any regard. It should be appreciated that calculation of hypertext 120 and/or region 146 dimension and/or position can be performed utilizing traditional and/or proprietary mechanisms. In one embodiment, the functionality described herein can be a capability of a screenshot application 160. It should be appreciated that screenshot 130 can include one or more interactive regions 146. It should be appreciated that the disclosure is not limited to hyperlinks and can support XLINK. It should be appreciated that the disclosure can support hyperlinks associated with images, audio, video, and the like.

In one embodiment, the disclosure can support intelligent reference 129 and/or metadata 124 extraction. In the embodiment, the disclosure can perform common Document Object Model (DOM) traversal to obtain parent level object references, child object references, and the like. For example, when a screenshot of a Web form is captured, the disclosure can extract Web form text data and the parent Web page hyperlink. It should be appreciated that the disclosure can utilize tagging information (e.g., meta tags) to perform intelligent data selection and/or extraction.

As used herein, resource 123 can be a digital resource which can be accessed via a computing device. Resource 123 can include, but is not limited to, a document, a task, an application, a device, a bookmark, a Web page, a Web form, and the like. Window manager 118 can be a system software which can control the placement and/or appearance of windows within a windowing system in a graphical user interface.

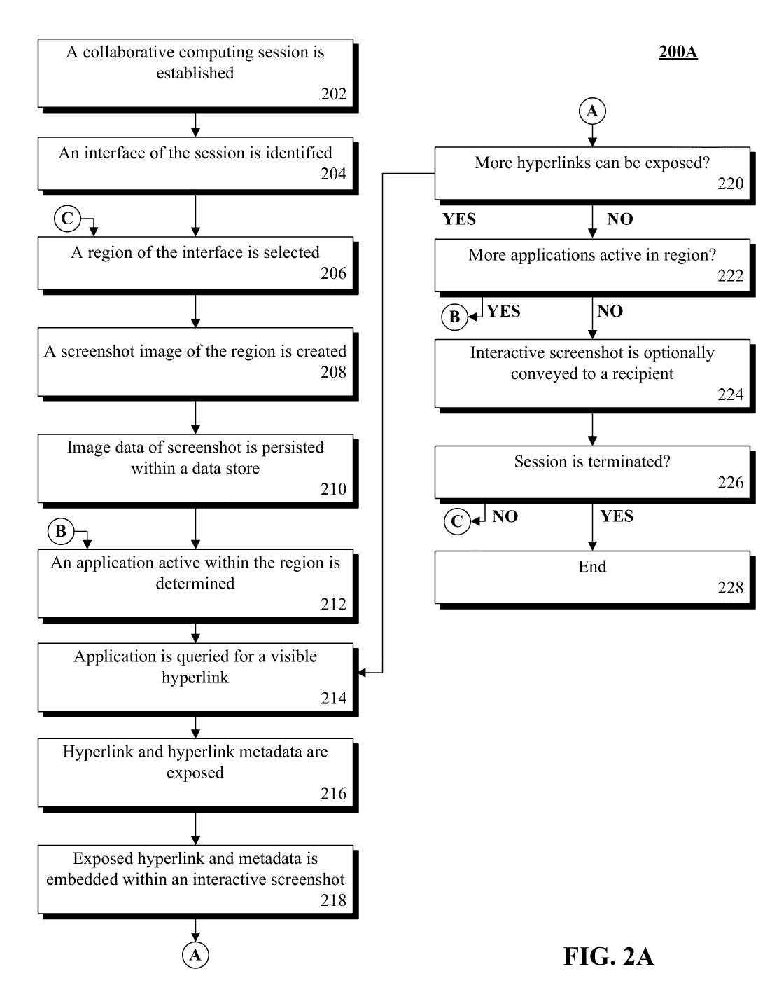

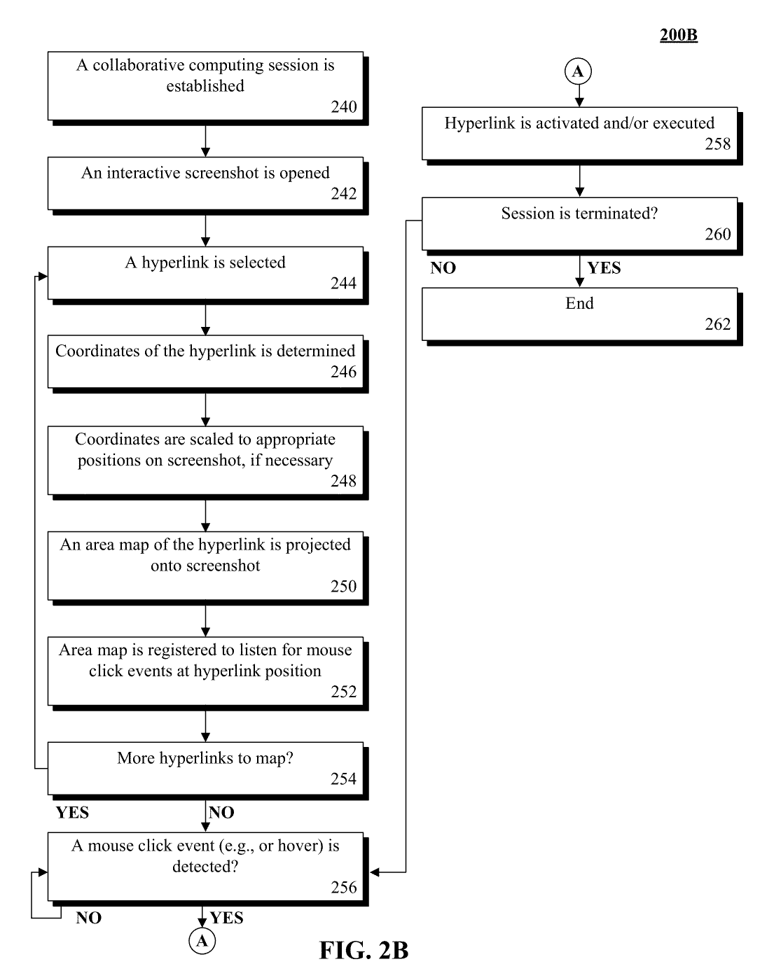

FIG. 2A is a schematic diagram illustrating a method 200A for creating an interactive screenshot in accordance with an embodiment of the inventive arrangements disclosed herein. In method 200A, an interactive screenshot can be automatically generated within a computing session when a screenshot is recorded.

In step 202, a collaborative computing session can be established. In step 204, an interface of the session can be identified. In step 206, a region of the interface can be selected. For example, a screenshot application can automatically select an application window which has input focus. In step 208, a screenshot of the region can be created. In step 210, image data of the screenshot can be persisted within a data store. In step 212, an application active within the region can be determined. In step 214, an application can be queried for a resource link present within the region. In step 216, hyperlink and hyperlink metadata can be exposed. In step 218, exposed hyperlink and hyperlink metadata can be embedded within an interactive screenshot. In step 220, if more hyperlinks can be exposed, the method can return to step 214, else continue to step 222. If there are more applications active within the region, the method can return to step 212, else continue to step 224. In step 224, the interactive screenshot can be optionally conveyed to a recipient. In step 226, if the session is terminated the method can continue to step 228, else return to step 206. In step 228, the method can end.

Drawings presented herein are for illustrative purposes only and should not be construed to limit the invention in any regard. It should be appreciated that method 200A can include one or more optional steps permitting the functionality of the method 200A is retained. Method 200A can be performed in serial and/or in context. Method 200A can be performed in real-time or near real-time.

FIG. 2B is a schematic diagram illustrating a method 200B for presenting and interacting with an interactive screenshot in accordance with an embodiment of the inventive arrangements disclosed herein. In method 200B, interactive regions associated with hyperlinks of an interactive screenshot can be presented upon viewing of the screenshot.

In step 240, a collaborative computing session can be established. In step 242, an interactive screenshot can be opened. In step 244, a hyperlink can be selected. Selection can be based on alphabetical order, numerical order, random order, and the like. In step 246, coordinates of the hyperlink can be determined. In step 248, coordinates can be scaled to appropriate positions on screenshot, if necessary. In step 250, an area map of the hyperlink can be projected onto the screenshot. In one step, area map can be visually denoted by a marquee, a highlighting, and the like. In step 252, the area map can be registered to listen for mouse click events at the hyperlink position. In step 254, if there are more hyperlinks to map, the method can return to step 244, else continue to step 256. In step 256, if a mouse click event (e.g., or hover) is detected, the method can continue to step 258, else return to step 256. In step 258, an appropriate hyperlink can be activated and/or executed. In step 260, if the session is terminated, the method can continue to step 262, else return to step 256. In step 262, the method can end.

Drawings presented herein are for illustrative purposes only and should not be construed to limit the invention in any regard. It should be appreciated that method 200B can include one or more optional steps permitting the functionality of the method 200B is retained. Method 200B can be performed in serial and/or in context. Method 200B can be performed in real-time or near real-time.

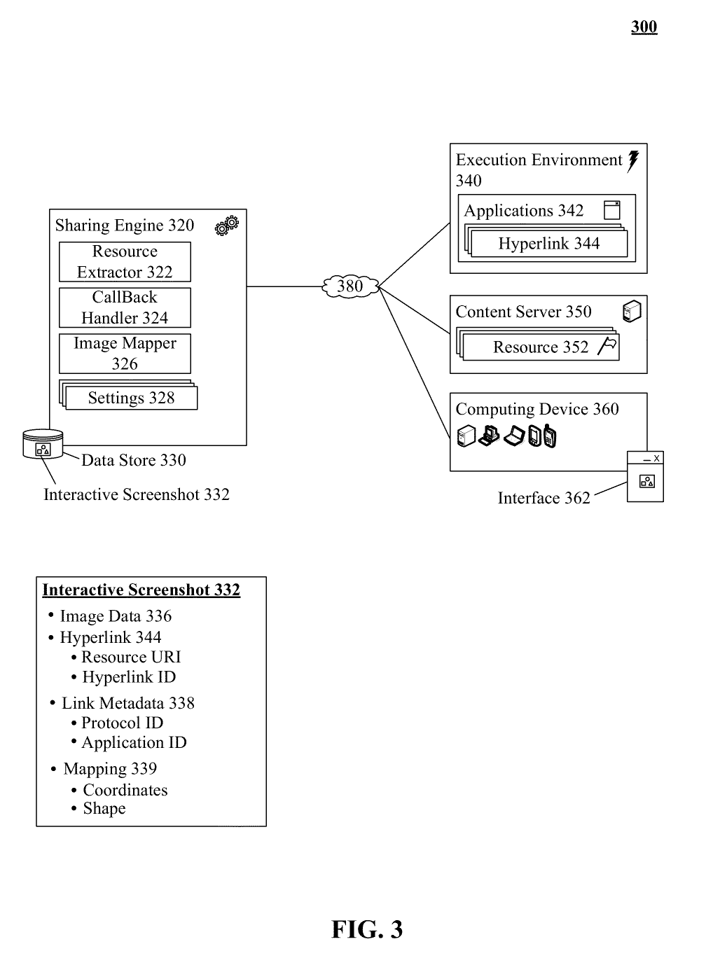

FIG. 3 is a schematic diagram illustrating a system 300 for enabling an interactive screenshot between collaborative applications in accordance with an embodiment of the inventive arrangements disclosed herein. In system 300, a sharing engine 320 can enabling resource 352 to be accessed via an interactive screenshot 332. System 300 components 320, 340, 350, 360 can be communicatively linked via one or more networks 380.

Sharing engine 320 can be a hardware/software entity for enabling an interactive screenshot functionality. Engine 320 can include, but is not limited to, a resource extractor 322, a callback handler 324, an image mapper 32, and the like. Engine 320 functionality can include, but is not limited to, screenshot image creation, screenshot 332 conveyance, and the like. In one embodiment, engine 320 can be a functionality of an IBM SAMETIME application. In one instance, engine 320 capabilities can be present within an Application Programming Interface (API). That is, the API functionality can extend legacy screenshot capture utilities (XWINDOWS XWD). In one embodiment, engine 320 can be a functionality of a Web based service.

In one instance, engine 320 can support shortened or aliased Uniform Resource Locators (URLs). In one embodiment, engine 320 can be utilized to access resources protected security measures including, but not limited to, firewalls, encryption, and the like. For example, engine 320 can be utilized to access a password protected document by validating login credentials for the document.

Resource extractor 322 can be a hardware/software element for extracting hyperlink 344 from applications 342 of execution environment 340. Extractor 322 functionality can include, but is not limited to, resource 352 identification, metadata 338 extraction, application 342 identification, and the like. In one instance, extractor 322 can determine coordinate and/or position information associated with hyperlink 344. In the instance, the information can be utilized to generate mapping 339. In one instance, extractor 322 can utilize an IBM WEBSHERE MESSAGE BROKER functionality to perform data extraction and/or application communication.

Callback handler 324 can be a hardware/software entity for managing callbacks associated with screenshot 332. Handler 324 can 324 functionality can include, but is not limited to, exception handling 324, messaging, and the like. It should be appreciated that handler 324 can be implemented utilizing traditional and/or proprietary mechanisms. Mechanisms can include, but is not limited to, subroutines, blocks, function pointers, and the like. In one instance, handler 324 can utilize link metadata 338 to store callback data necessary for executing a callback functionality. In one instance, handler 324 can utilize an XML-Remote Procedure Call (RPC) to communicate over Hypertext Transport Protocol (HTTP) to perform the functionality described herein.

Image mapper 326 can be a hardware/software element for enabling an interactive region (e.g., mapping 339) within screenshot 332. Mapper 326 functionality can include, but is not limited to, mapping 339 generation, event handling, and the like. In one embodiment, mapper 326 can utilize a traditional Hypertext Markup Language (HTML) or an Extensible HTML (XHTML) image mapping feature to achieve screenshot 332 functionality.

Settings 328 can be one or more rules for establishing the behavior of system 300, engine 320, and the like. Settings 328 can include, but is not limited to, resource extractor 322 options, callback handler 324 settings, image mapper 326 options, and the like. In one instance, settings 328 can be manually and/or automatically established. In the embodiment, settings 328 can be heuristically established based on historic settings. Settings 328 can be persisted within data store 330, computing device 360, and the like.

Data store 330 can be a hardware/software component able to persist table 332, settings 328, and the like. Data store 330 can be a Storage Area Network (SAN), Network Attached Storage (NAS), and the like. Data store 330 can conform to a relational database management system (RDBMS), object oriented database management system (OODBMS), and the like. Data store 330 can be communicatively linked to engine 320 in one or more traditional and/or proprietary mechanisms. In one instance, data store 330 can be a component of Structured Query Language (SQL) complaint database.

Interactive screenshot 332 can be an image file associated with one or more resources 352. Screenshot 332 format can conform to a Joint Photographic Expert Group (JPEG), Graphics Interchange Format (GIF), Portable Network Graphics (PNG), and the like. Screenshot 332 can include, but is not limited to, image data 336, hyperlink 334, link metadata 338, mapping 339, and the like. In one embodiment, interactive regions associated with screenshot 332 can be Common Object Request Broker Architecture (CORBA) object references.

Execution environment 340 can be a computing environment able to execute applications 342. Environment 340 can conform to a distributed computing environment, a networked computing environment, and the like. In one embodiment, environment 340 can be a collaborative environment such as a groupware environment. For example, environment 340 can be an IBM NOTES enterprise collaboration software. Applications 342 can be software programs able to process and/or present hyperlink 344. Applications 342 can include, but is not limited to, Rich Internet Applications (Web applications), desktop applications, groupware applications, and the like. For example, applications 342 can be an IBM iNOTES application.

Content server 350 can be a hardware/software entity for persisting and/or exposing resource 352. Server 350 can include, but is not limited to, an application server, a database server, a Web server, digital asset management server, and the like. In one instance, server 350 can be a component of environment 340.

Computing device 360 can be a software/hardware element for executing interface 362 and/or screenshot 332. Device 360 can include, but is not limited to, input components (e.g., keyboard), interface 362, an application, output components (e.g., display), and the like. Device 360 hardware can include, but is not limited to, a processor, a non-volatile memory, a volatile memory, a bus, and the like. Computing device 360 can include, but is not limited to, a desktop computer, a laptop computer, a mobile phone, a mobile computing device, a portable media player, a PDA, and the like. Interface 362 capabilities can include a graphical user interface (GUI), voice user interface (VUI), mixed-mode interface, and the like.

Network 380 can be an electrical and/or computer network connecting one or more system 300 components. Network 380 can include, but is not limited to, twisted pair cabling, optical fiber, coaxial cable, and the like. Network 380 can include any combination of wired and/or wireless components. Network 380 topologies can include, but is not limited to, bus, star, mesh, and the like. Network 380 types can include, but is not limited to, Local Area Network (LAN), Wide Area Network (WAN), VPN and the like

Drawings presented herein are for illustrative purposes only and should not be construed to limit the invention in any regard. It should be appreciated that one or more components within system 300 can be optional components permitting that the disclosure functionality be retained. It should be understood that engine 320 components can be optional components providing that engine 320 functionality is maintained. It should be appreciated that one or more components of engine 320 can be combined and/or separated based on functionality, usage, and the like. System 300 can conform to a Service Oriented Architecture (SOA), Representational State Transfer (REST) architecture, and the like.

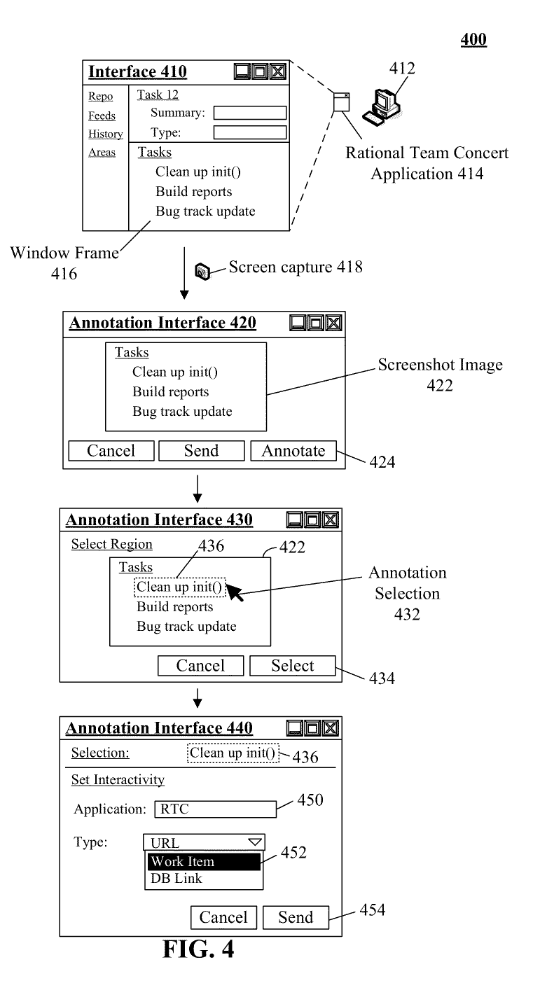

FIG. 4 is a schematic diagram illustrating a set of interfaces 400 for enabling an interactive screenshot between collaborative applications in accordance with an embodiment of the inventive arrangements disclosed herein. In interfaces 400, a screenshot of an interface 410 can be captured and annotated to permit the annotated screenshot to have the capabilities of an interactive screenshot described herein.

Interface 410 can be a screen of an IBM RATIONAL TEAM CONCERT application executing on a computing device 412. Interface 410 can include one or more windows, window frames, and the like. For example, interface 410 can conform to a traditional Integrated Development Editor (IDE) layout. In window frame 416, a task list can be presented. For example, the task list can include one or more work items of a project associated with a software development team. A screen capture action 418 can be performed which can capture an image of window frame 416.

Screenshot image 422 created from screen capture 418 can be presented within an interface 420. Interface 420 can be an interface of a screenshot application, a collaborative application, a messaging application, and the like. For example, interface 420 can be a screen of a Rational Team Concert application 414. Interface 420 can present an option to annotate screenshot image 422. Upon selection of annotate 424 interface element (e.g., button), an interface 430 can be presented. It should be appreciated that interface 420 can be an optional interface which can be omitted.

Interface 430 can present screenshot image 422 and present one or more options for performing annotation functionality. In one embodiment, the interface 430 can permit an annotation selection 432 which can allow the selection of a bounded region 436. In the embodiment, one or more interactive actions can be assigned to the region 436 within an interface 440. Upon selection of select 434 interface element (e.g., button), an interface 440 can be presented.

Interface 440 can display bounded region 436 and permit assignment of one or more interactive options associated with region 436. In one embodiment, interface 440 can permit the region 436 to be associated with an application. In the embodiment, input box 450 can enable the automated and/or manual selection of an application. It should be appreciated that input box 450 can include a drop down selection widget, a file selection widget, and the like. Interface 440 can permit the assignment of a content type of a region 436. In one instance, the content type can be specified utilizing drop down selection widget 452. For example, region 436 can be assigned as a work item of an application 414. In one configuration of the instance, the widget 452 can automatically detect the content type utilizing one or more traditional and/or proprietary techniques. Upon selection of send interface element (e.g., button), the interface 440 can initiate a file transfer process. The file transfer can include assignation of a recipient, compression, encryption, and the like. It should be appreciated that file transfer can be associated with an email (e.g., email attachment), MMS messaging, text exchange file transfer (e.g., instant message Direct Connect), and the like.

Drawings presented herein are for illustrative purposes only and should not be construed to limit the invention in any regard. It should be appreciated that interfaces 420, 430, 440 can be screens of a software wizard.

The flowchart and block diagrams in the FIGS. 1-4 illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for an interactive screenshot comprising:
identifying a resource link within a selected portion of an interface executing within a computing device, wherein the resource link comprises of at least one of a visible interface element and a non-visible reference to a resource, wherein the reference is at least one of a Uniform Resource Locator and a Uniform Resource Identifier;
establishing the identity of an application associated with the interface, wherein the identity is at least one of an application identifier and a process identifier;
determining the position and dimensions of the visible interface element of the resource link within the selected portion of the interface;
capturing a screenshot image of the current state of the selected portion of the interface, wherein the current state comprises of a visual representation of the visible interface element;
encoding the position and dimensions of the visible interface element within an image map, wherein the encoding maps a bounded region surrounding the visual representation of the visible interface element within the screenshot corresponding to the visible interface element position and the dimensions of the resource link within the interface; and
associating the bounded region with the identity of the application and the reference.

2. The method of claim 1, further comprising:
embedding the image map within the screenshot image.

3. The method of claim 1, further comprising:
registering the bounded region with an event handler as an interactive area, wherein selection of the region triggers a programmatic action which accesses the resource based on the identity of the application.

4. The method of claim 1, further comprising:
responsive to selecting the bounded region, presenting the resource within a different application executing within a different computer.

5. The method of claim 1, further comprising:
persisting the image map within a data store separate from the screenshot image; and
responsive to conveying the screenshot image to a destination, subsequently conveying the image map to the destination.

6. The method of claim 1, further comprising:
querying an operating system executing on the device for a resource link in the selected portion of the interface.

7. The method of claim 1, further comprising:
identifying an application executing within the selected portion; and
querying the application for data associated with the resource link.

8. The method of claim 1, further comprising:
embedding a resource link data and respective location obtained from an operating system into the screenshot image when the visible interface element of the resource link is visible in the image.

9. The method of claim 1, wherein the method is performed within a Web conference session.

10. A system for an interactive screenshot comprising:
a content sharing engine configured to create an interactive screenshot comprising of at least one interactive region, wherein responsive to selecting the at least one interactive region, the sharing engine is able to access a resource associated with the region, wherein the screenshot is a recorded image of a selected portion of an application interface executing within a computing device;
a data store able to persist at least one of a screenshot image, a link metadata, and a mapping.

11. The system of claim 10, further comprising:
a resource extractor configured to query an operating system executing on the device for a resource link in the selected portion of the application interface;
a callback handler able to present the resource associated with the region within a different application executing within a different computer, responsive to selecting the interactive region; and
an image mapper configured to embed the link metadata obtained from an operating system into the screenshot image when a visible interface element of the resource link is visible in the image.

12. The system of claim 10, further comprising:
the engine configured to identify an application executing within the selected portion; and
the engine able to query the application for data associated with a resource link.

13. The system of claim 10, wherein the system is a functionality of a teleconferencing software.

14. The system of claim 10, further comprising:
the engine able to embed the image map within the recorded image.

15. The system of claim 10, further comprising:
the engine configured to persist the mapping data within a data store separate from the recorded image; and
the engine able to subsequently convey the mapping data to a destination responsive to conveying the recorded image to the destination.

16. The system of claim 10, further comprising:
the engine configured to present the resource within a different instance of the application executing within a different computer responsive to selecting the bounded region.

17. The system of claim 10, further comprising:
the engine able to extract coordinates from the mapping data for an interactive region, wherein the interactive region is a bounded polygon;
the engine configured to determine a scaling factor associated with a target interface configured to present the image;
scaling the coordinates based on the scaling factor; and
projecting the region onto the image responsive to the scaling.

18. A computer program product comprising a computer readable storage medium having computer usable program code embodied therewith, the computer usable program code comprising:
computer usable program code stored in a storage medium, if said computer usable program code is executed by a processor it is operable to identify a resource link within a selected portion of an interface executing within a computing device, wherein the resource link comprises of at least one of a visible interface element and a non-visible reference to a resource, wherein the reference is at least one of a Uniform Resource Locator and a Uniform Resource Identifier;
computer usable program code stored in a storage medium, if said computer usable program code is executed by a processor it is operable to establish the identity of an application associated with the interface, wherein the identity is at least one of an application identifier and a process identifier;
computer usable program code stored in a storage medium, if said computer usable program code is executed by a processor it is operable to determine the position and dimensions of the visible interface element of the resource link within the selected portion of the interface;
computer usable program code stored in a storage medium, if said computer usable program code is executed by a processor it is operable to capture a screenshot image of the current state of the selected portion of the interface, wherein the current state comprises of a visual representation of the visible interface element;
computer usable program code stored in a storage medium, if said computer usable program code is executed by a processor it is operable to encode the position and dimensions of the visible interface element within an image map, wherein the encoding maps a bounded region surrounding the visual representation of the visible interface element within the screenshot corresponding to the visible interface element position and the dimensions of the resource link within the interface; and
computer usable program code stored in a storage medium, if said computer usable program code is executed by a processor it is operable to associate the bounded region with the identity of the application and the reference.

19. The computer program product of claim 18, wherein the product is configured to embed the image map within the screenshot image.

20. The computer program product of claim 18, wherein the product is an IBM SAMETIME software.
